(19) United States
(12) Patent Application Publication
(10) Pub. No.: US 2019/0000232 A1
(43) Pub. Date: Jan. 3, 2019

(54) GRIP MEMBER OF OVERTURN PREVENTING DEVICE AND THE OVERTURN PREVENTING DEVICE

(71) Applicant: KYB CORPORATION, Minato-ku, Tokyo (JP)

(72) Inventors: Masaya UNE, Minato-ku, Tokyo (JP); Yukiko ISHIHARA, Minato-ku, Tokyo (JP); Akihisa OTA, Minato-ku, Tokyo (JP)

(73) Assignee: KYB CORPORATION, Minato-ku, Tokyo (JP)

(21) Appl. No.: 16/064,726

(22) PCT Filed: Dec. 22, 2016
(86) PCT No.: PCT/JP2016/088456

§ 371 Date: Jun. 21, 2018

(30) Foreign Application Priority Data
Dec. 24, 2015 (JP) 2015-251092

(51) Int. Cl. A47B 97/00

(52) U.S. Cl. CPC A47B 97/00; F16F 9/516; A47B 2097/008

(57) ABSTRACT

Providing a construction that can allow a ceiling side base to be relocated easily even after the overturn preventing device has been mounted between a top surface of an article and a ceiling. A grip member is attached to an overturn preventing device including a damper to be mounted between the top surface of the furniture and a pair of bases respectively connected to both ends of the damper. One of the bases abuts against the top surface of the furniture and the other base abuts against the ceiling. The grip member includes a through hole part locked to the ceiling side second base and a grip part connected to the through hole part and drooping below the second base in a mounted state where the second base is in abutment against the ceiling

### TECHNICAL FIELD

The present invention relates to a grip member of an overturn preventing device and the overturn preventing device.

### BACKGROUND ART

Patent Document 1 discloses a conventional overturn preventing device. This overturn preventing device includes a damper and a pair of bases. The damper is mounted between a top surface of a piece of furniture installed on a floor and a ceiling. The damper has two ends respectively supported by the paired bases to be rotatable about rotation axes. One of the bases abuts against the top surface of the furniture and the other base abuts against the ceiling. As a result, in this overturn preventing device, when the furniture is tilted by shaking of earthquake or the like in a direction parallel to a rotation direction of the damper, the damper is rotated about the rotation axes relative to the bases so that the bases can be maintained in abutment against the top surface of the furniture and the ceiling respectively. As a result, this overturn preventing device can apply a damping force of the damper to the furniture thereby to suppress the tilt of the furniture and prevent the furniture from

### PRIOR ART DOCUMENT

### Patent Documents

Patent Document 1: Japanese Patent Application Publication No. JP 2015-6330

### SUMMARY OF THE INVENTION

### Problem to be Overcome by the Invention

Once the damper of the overturn preventing device of Patent Document 1 has been mounted between the top surface of the furniture and the ceiling, the ceiling side base is pressed against the ceiling by a strong force due to a spring property in a direction of extension by the gas pressure of compressed gas, with the result that the ceiling side base is held with a strong friction force. Therefore, when the ceiling side base is to be moved after the mounting for some reason, for example, when the installation position of the ceiling side base is to be finely adjusted, the ceiling side base needs to be moved downward against the biasing force of the damper so that a frictional force is prevented from being generated between the ceiling side base and the ceiling, and then the ceiling side base needs to be moved further. However, in the first place, it is difficult for a worker to directly hold and downwardly move the base installed at a high position near the ceiling. It is extremely difficult for the worker to accurately move the base to a desired location while carrying out such a burdensome work.

The present invention was made in view of the above-described circumstances in the conventional art and has an object to provide a grip member and an overturn preventing device provided with the grip member which can allow the ceiling side base to be relocated easily even after the overturn preventing device has been mounted between the top surface of an article and the ceiling.

### Means for Overcoming the Problem

A grip member in accordance with the present invention is attached to an overturn preventing device including a damper to be mounted between a top surface of an article installed on an installation surface and a ceiling, and a pair of bases respectively coupled to both ends of the damper. One of the bases abuts against the top surface of the article and the other base abuts against the ceiling. The grip member includes a locking part locked to the base at the ceiling side and a grip part connected to the locking part and drooping below the ceiling side base in a mounted state in which the ceiling side base is in abutment, against the ceiling.

In the grip member of the present invention, when the overturn preventing device is mounted so that one of the bases abuts against the top surface of the article and the other base abuts against the ceiling, the grip part connected to the locking part droops below the ceiling side base with the locking part being locked to the ceiling side base. Since the grip member is thus constructed, when having a desire to change the location of the ceiling side base, the worker can easily detach the base from the ceiling against the biasing force of the damper by pulling the grip part downward while gripping the grip part drooping downwardly. The ceiling side base can be moved to a desired location by moving the grip part while a frictional force is prevented from being generated by such a pulling operation. In particular, when the location of the ceiling side base is to be changed, the worker can operate a portion located nearer than the ceiling side base, and moreover, the worker can operate while gripping the drooping grip part. As a result, the worker can easily do the work in a posture allowing the worker to apply a strong force.

Accordingly, the grip member of the invention can allow the ceiling side base to be relocated easily even after the overturn preventing device has been mounted between the top

The ceiling side base may include a body and a rotating shaft member which is assembled to the body and rotatably holds one of the ends of the damper. The rotating shaft member may have two ends respectively protruding at both sides of a central axis of the damper along a direction intersecting with the central axis. A pair of the locking parts may be locked to the ends of the rotating shaft member respectively. In the case where the paired locking parts are respectively locked to both ends of the rotating shaft member which rotatably holds the end of the damper, when the grip part connected to the locking parts is pulled downward, the pull force efficiently acts for compression of the damper. Accordingly, the pull force applied to the grip part required to detach the ceiling side base from the ceiling can be reduced more, with the result, that the relocation operation can be carried out more easily.

The grip member may include connecting parts connected be caused to come close to each other so that a distance therebetween is shorter than a distance between the locking parts, thereby forming a narrowed part. The grip part may be formed into an annular shape while located below the narrowed part, in the mounted state in which the ceiling side base is in abutment against the ceiling. When the grip part is thus formed into an annular shape, the worker can easily grip the grip part and easily apply the downward pull force. Furthermore, the narrowed part is located between the paired locking parts and the grip part in the mounted state in which the ceiling side base is in abutment against the ceiling. Accordingly, when the grip part is pulled downward, the paired locking parts are subjected not only to the downward force but also to a force applied in the direction such that, the locking parts come close to each other. As a result, the paired locking parts are rendered less likely to be detached outwardly from, the respective ends of the rotating shaft member.

The grip member may be made of an elastically deformable material and be formed into an elongated, shape in an extended state. The grip member may be formed with one of the locking parts at a location near one of two longitudinal ends thereof and formed with the other locking part at a location near the longitudinal other end thereof. The grip member may be formed with a through hole part located between the locking parts. The grip member may such that, either connecting part is passed through the through hole part. According to this configuration, an annular grip part, which is easy to grip can be constructed with the simple structure such that the locking parts are respectively formed near both ends of the elastically deformable elongated material and the through hole part is formed therebetween. Furthermore, the paired locking parts can be rendered less likely to be detached.

The grip member may further include a first attachment member including the locking part and the grip part. The first attachment member may be attached to the ceiling side base. The grip member may further include a second attachment member including a second locking part locked to the article side base and a second grip part connected to the second locking part. The second attachment member may be attached to the article side base. Furthermore, the grip member may include a coupling member coupling the first and second attachment members. In the grip member thus constructed, the first and second attachment members and the coupling member may be connected to one another between the ceiling side base and the article side base, thereby holding the damper in a contracted state in which the damper has a desired length.

As the result of use of this grip member, the damper of the overturn preventing device can be held in the contracted state with a desired length. When the coupling member is loosened or cut after one of the bases of the overturn preventing device in the above-described contracted state has been placed on the top surface of the article, the damper is extended so that the other base abuts against the ceiling, whereby the mounting work can be finished. As the result of realization of such a mounting manner, the worker need not carry out the mounting work while contracting the damper above the article, so that the overturn preventing device can easily be mounted between the top surface of the article and the ceiling. Furthermore, when the respective bases are mounted at the ceiling side and the article side by loosening or cutting the coupling member, the grip part connected to the locking part droops below the ceiling side base. Accordingly, the ceiling side base can easily be relocated after the mounting by moving the grip part while holding and pulling the grip part. On the other hand, the second attachment member remains attached to the article side base. Accordingly, when the article side base is to be relocated. It is possible to operate while griping the second grip part of the second attachment member so as to pull up and move the article side base. Accordingly, the work of adjusting the location of the article side base can also be rendered easier. Furthermore, after the mounting has been carried out by loosening or cutting the coupling member, the first and second attachment members respectively remain attached to the ceiling side and article side bases. Accordingly, the overturn preventing device can be set again into the contacted state by coupling the first and second attachment members so as to come close to each other using the above-mentioned coupling member or a new member. In other words, the mounting work in reinstallation of the overturn preventing device can also be rendered easier.

Furthermore, an overturn preventing device may include the grip member in accordance with the invention, a damper and a pair of bases. According to the construction, the overturn preventing device which can allow the ceiling side base to be easily relocated can be realized.

Here, the article includes furniture, a bed having a plurality of beds connected to each other in the up-down direction, large sized televisions, refrigerators, bookshelves, showcases, server racks, and the like all of which have a possibility of being overturned by shaking of earthquake or the like.

### BRIEF DESCRIPTION OF THE DRAWINGS

FIG. 1 is a side view of the overturn preventing device of a first embodiment, mounted between a top surface of furniture and the ceiling;

FIG. 2 is a partially sectional front view of the overturn preventing device of the first embodiment, mounted between the top surface of the furniture and the ceiling;

FIG. 3 is a partial cross section of a damper and a first base of the overturn preventing device of the first embodiment;

FIG. 4 is a perspective view of the damper, the first base, and a fall preventing part of the overturn preventing device of the first embodiment;

FIG. 5 is a partial cross section of the damper, the first base, and the fall preventing part in the first embodiment;

FIG. 6 is a partial cross section of the damper, the first base, and an angle regulator of the overturn preventing device of the first embodiment;

FIG. 7 is a perspective view of the overturn preventing device of the first embodiment, schematically showing a midway step of mounting the overturn preventing device between the top surface of the furniture and the ceiling;

FIG. 8 is a plan view of a band member used with the overturn preventing device of the first embodiment;

FIG. 9 is a schematic perspective view of the overturn preventing device of the first embodiment mounted between the top surface of the furniture and the ceiling;

FIG. 10 is a side view of the overturn preventing device of a third embodiment mounted between the top surface of the furniture and the ceiling;

FIG. 11 is a front, view of the overturn preventing device of the third embodiment mounted between the top surface of the furniture and the ceiling;

FIG. 12 is a side view of the overturn preventing device of a fourth embodiment mounted between the top surface of the

FIG. 13 is a front view of the overturn preventing device of the fourth embodiment mounted between the top surface of the furniture and the ceiling;

FIG. 14 is a schematic perspective view of the overturn preventing device of a fifth embodiment mounted between the top surface of the furniture and the ceiling;

FIG. 15 is a plan view of the band member used with the overturn preventing device of the fifth embodiment;

FIG. 16 is a partially sectional front view of the overturn preventing device of a sixth embodiment, schematically showing a midway step of mounting the overturn preventing device between the top surface of the furniture and the ceiling; and

FIG. 17 is a front view of the overturn preventing device of the sixth embodiment mounted between the top surface of the furniture and the ceiling.

### BEST MODE FOR CARRYING OUT THE INVENTION

A first embodiment of the overturn preventing device of the present invention will be described with reference to the drawings.

### First Embodiment

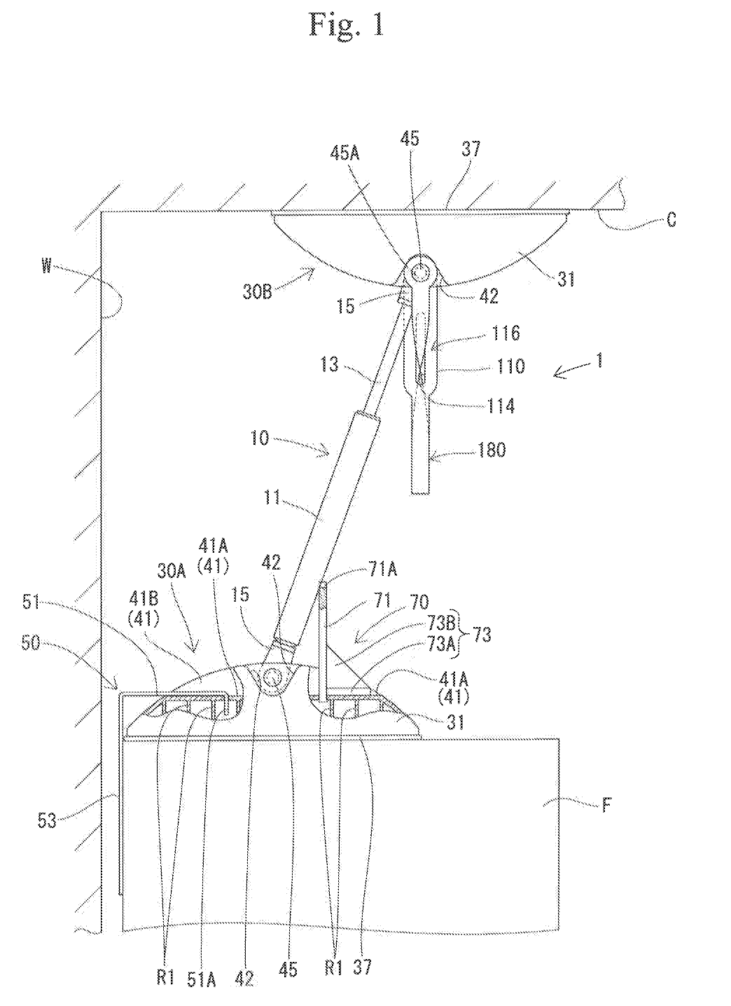

At least one overturn preventing device 1 of the first embodiment is mounted between a top surface of a piece of furniture F and a ceiling C, as illustrated in FIG. 1. The furniture F is installed on a floor surface (not illustrated) serving as an installation surface while a rear surface of the furniture F is opposed to a wall surface W extending in a vertical direction from the floor surface. The furniture F is formed into a rectangular parallelepiped shape, for example, and has a door, drawers (neither illustrated) and the like in a front surface (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device 1 as illustrated in FIG. 1 is not mounted on the furniture F, the furniture F would possibly be tilted frontward (rightward in FIG. 1) by shaking of earthquake or the like thereby to be overturned.

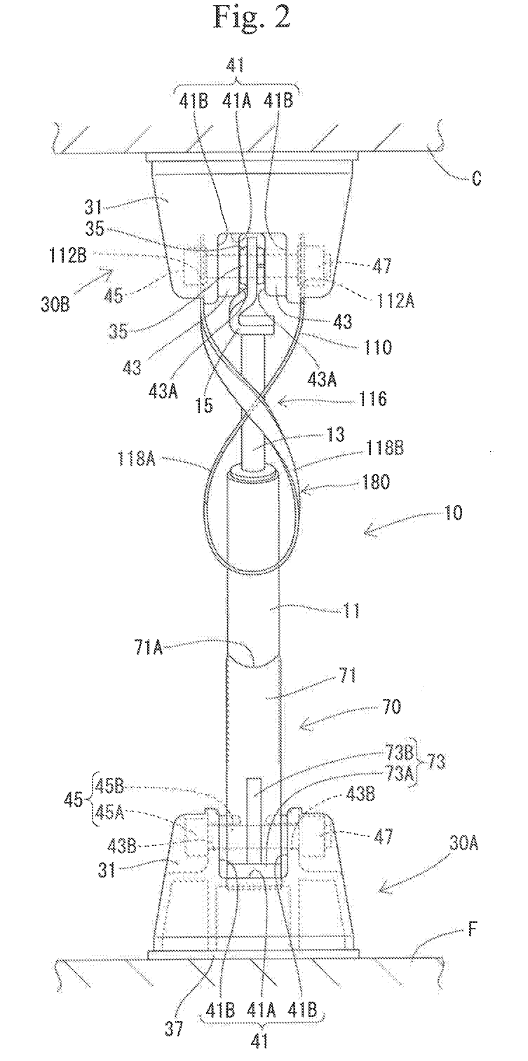

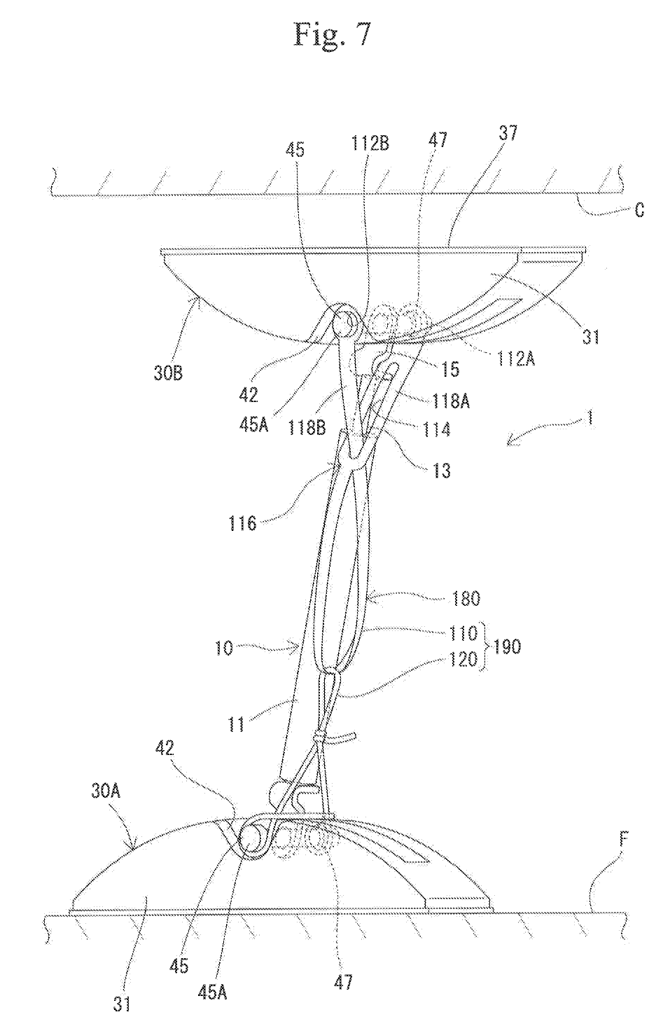

The overturn preventing device 1 includes a damper 10, a pair of bases 30A and 30B, a fall preventing part 50, and an angle regulator 70, as illustrated in FIGS. 1 and 2. The overturn preventing device 1 further includes a fixing cord 190 as illustrated in FIG. 7.

The damper 10 has a cylinder 11, a rod guide (not illustrated), a piston (not illustrated), a rod 13, and two joints 15 respectively provided on both ends of the damper 10. The cylinder 11 is bottomed and has a cylindrical shape. The rod guide closes an opening of the cylinder 11. The piston is slidably inserted in the cylinder 11. The rod 13 has a proximal end connected to the piston. The rod 13 is inserted through the rod guide, so that a distal end thereof protrudes out of the cylinder 11. A hydraulic fluid and a compressed gas are enclosed in the cylinder 11. Each joint 15 is formed by bending a fiat plate-shaped metal fitting as illustrated in FIGS. 1 to 3. The joints 15 are respectively connected to a bottom of the cylinder 10 and the distal end of the rod 13. Each joint 15 is formed with a through hole 15A extending therethrough in a direction perpendicular to an axis line of the damper 10.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10. An expansion force of the compressed gas enclosed in the cylinder 11 works in an extension direction of the damper 10.

The following will describe a mechanism of generating a damping force by the damper 10. Since the mechanism has a known structure, diagrammatic representation is eliminated. The cylinder 11 has an interior divided by the piston into a rod side pressure chamber in which the proximal end of the rod 13 is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the extending/contracting operation of the damper 10. Furthermore, the piston is formed with a communication path communicating with both pressure chambers via a check valve. The check valve allows the hydraulic fluid to flow from the rod side pressure chamber to the counter-rod side pressure chamber and blocks reverse flow of the hydraulic fluid. Accordingly, the damper 10 has two flow paths of the hydraulic fluid from the rod side pressure chamber to the counter-rod side pressure chamber during the extending operation, that is, one flow path including the orifice and the other flow path including the communication path. On the other hand, the damper 10 has only one flow path of the hydraulic fluid from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

The paired bases 30A and 30B are respectively a first base 30A to which the joint 15 connected to the bottom of the cylinder 11 is coupled and a second base 30B to which the joint 15 connected to a distal end of the rod 13 is coupled, as illustrated in FIGS. 1 and 2. The first base 30A is placed in abutment on the top surface of the furniture F, and the second base 30B abuts against the ceiling. The first and second bases 30A and 30B have the same form and the same structure. Each of the bases 30A and 30B has a base body 31, a bolt 45 and a nut 47 serving as a rotating shaft member, a bush 35, and a slip preventing part 37, as illustrated

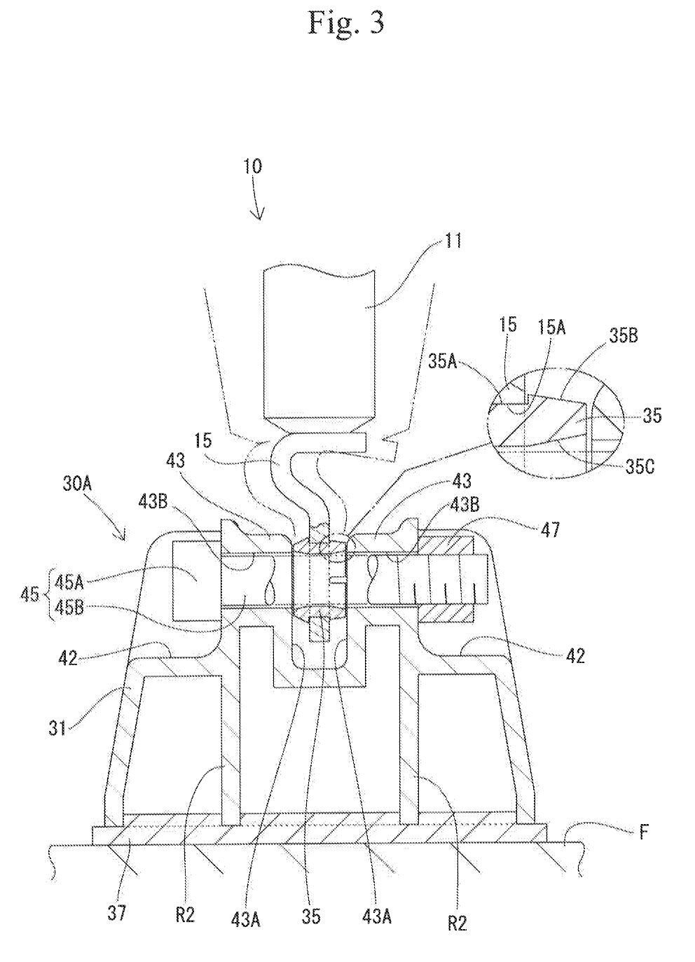

The base body 31 has a rectangular outer shape in a planar view as viewed from above in a state where the first base 30A is placed in abutment on the top surface of the furniture F. Hereinafter, a direction in which a long side in the outer shape of the base body 31 extends in this planar view will be referred to as “a long side direction” and a direction in which a short side extends will be referred to as “a short side direction”. Furthermore, in a side view of the first base 30A as viewed, in the short side direction in the state where the first base 30A is placed in abutment on the top surface of the furniture F, the base body 31 has a lower edge which extends straightforward in parallel to the top surface of the furniture F and an upper edge which upwardly bulges from, both sides of the lower edge thereby to have an arc-shaped outer shape (refer to FIG. 1). Still furthermore, in a side view of the first base 30A as viewed, in the long side direction in the state where the first base 30A is placed in abutment on the top surface of the furniture F, the base body 31 has a trapezoidal outer shape in which the upper edge is shorter than the lower edge (refer to FIGS. 2 and 3).

In the first base 30A placed in abutment on the top surface of the furniture F, the base body 31 has a groove 41 which is formed in an upper surface thereof and extends in the long side direction (a right-left direction as viewed in FIG. 1 and a depthwise direction as viewed in FIGS. 2 and 3). The groove 41 has a bottom 41A spreading on a horizontal surface and inner wall surfaces 41B respectively rising from both sides of the bottom 41A substantially in a vertical direction. The bottom 41A of the groove 41 extends substantially at a middle of the base body 31 in the up-down direction. Furthermore, the bottom 41A of the groove 41 has a constant width except for a portion formed with a pair of convex portions 43 which will be described later.

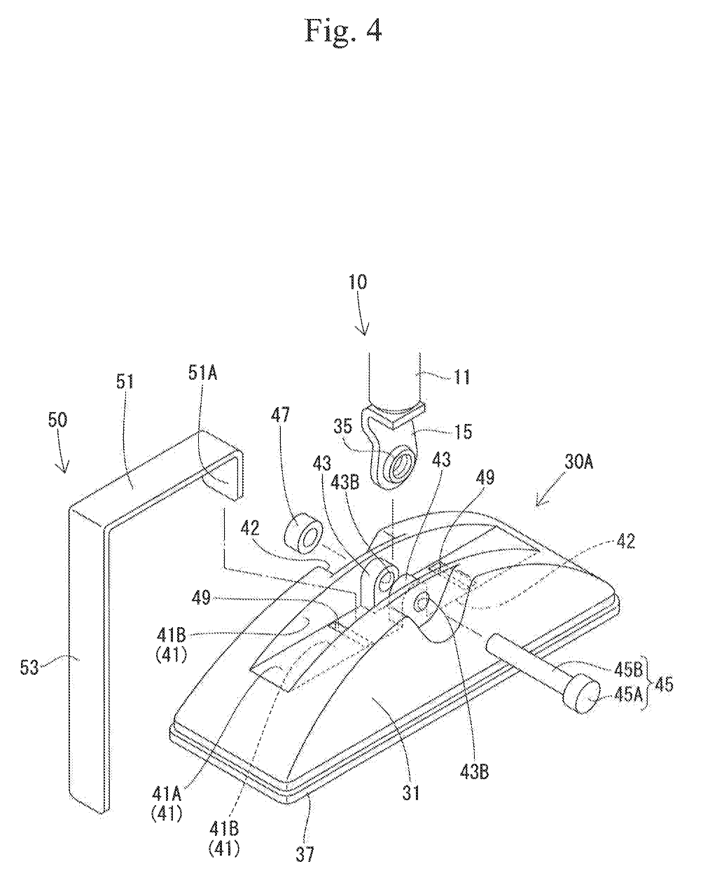

The groove 41 has the paired convex portions 43 which are formed at a central part thereof in the long side direction to protrude from the bottom 41A and both inner wall surfaces 41B of the groove 41, as illustrated in FIG. 4. A space is defined between the convex portions 43 as illustrated in FIGS. 2 and 3. The joint 15 of the damper 10 and a bush 35 which will be described later are fitted into the space. The space communicates with the groove 41. A distance (a dimension of the space in the short, side direction) between the inner wall surfaces 43A of the convex portions 43 is slightly longer than a length of the bush 35. The convex portions 43 respectively have insertion holes 43B which are formed to extend through upper central parts thereof in the short, side direction and through which a shaft part 45B of the bolt 45, which will be described later, is inserted.

A pair of locked holes 49 is formed in the bottom 41A of the groove 41 as illustrated in FIG. 4. The locked holes 49 are formed so that respective distances from the convex portions 43 toward both ends of the groove 41 are substantially equal to each an entire width of the groove 41. In other words, each locked hole 4 9 has a length equal to the width of the groove 41 and a width that is slightly larger than a thickness of a locking part 51A of the fall preventing part 50 and a thickness of an insertion part 71B provided in the angle regulator 70 which will be described later. One of the locked holes 49 serves as a locked part into which the locking part 51A of the fail preventing part 50 is inserted thereby to be locked. The other locked hole 49 serves as a locked part into which the insertion part 71B provided in the angle regulator 70 is inserted thereby to be locked.

In the first base 30A placed in abutment on the top surface of the furniture F, the base body 31 has recesses 42 respectively formed in both sides of the groove 41 in the middle in the long side direction. The recesses 42 are each open upward and outward with respect to the short side direction. The recesses 42 each have a side, in which the insertion hole 43B formed through the convex portion 43 is open. A head 45A of the bolt 45 and the nut 47 screwed onto the bolt 45 which will be described, later are respectively disposed in the recesses 42. The recesses 42 are formed to be upwardly spread in the long side direction so that tools can be fitted with the bolt head 45A and the nut 47 from above.

The base body 31 is hollow as illustrated in FIGS. 1 to 3. The base body 31 is downwardly open in the first base 30A placed in abutment on the top surface of the furniture F. The base body 31 has a plurality of ribs R1 extending in parallel to the short side direction in the inside thereof and two ribs R2 extending in parallel to the long side direction in the inside thereof so that the ribs R1 and the ribs R2 intersect with each other.

The rotating shaft member includes the bolt 45 inserted from one of the insertion holes 43B of the base body 31 and the nut 47 screwed onto the shaft part 45B of the bolt 45, as illustrated in FIGS. 2 and 3. Central axes of the respective bolts 45 serve as rotation axes of the damper 10 in the bases 30A and 30B.

bush 35 is substantially cylindrical in shape as illustrated in FIG. 3. The bush 35 is an elastic body. The bush 35 has a length that is slightly smaller than a distance between the inner wall surfaces 43A of the paired convex portions 43 provided in the base body 31. The bush 35 is formed with a concave portion 35A going around a central part of the outer peripheral surface thereof. The concave portion 35A has an outer diameter that substantially equals an inner diameter of the through hole 15A formed through the joint 15 of the damper 10. The bush 35 has portions rising from both ends of the concave portion 35A which portions have outer diameters larger than the inner diameter of the through hole 15A of the joint 15. Furthermore, both ends of the bush 35 have respective outer peripheral surfaces 35B the diameters of which are outwardly reduced. As a result, the bush 35 is inserted into the through hole 15A of the joint 15 of the damper 10 while being elastically deformed. The concave portion 35A is then fitted into the through hole 15A so that the bush 35 is attached to the joint 15 of the damper 10.

The central part of the bush 35 has an inner diameter slightly larger than an outer diameter of the shaft part 45B of the bolt 45. Both ends of the bush 35 have inner peripheral surfaces 35C the diameters of which are outwardly enlarged. Accordingly, the bush 35 is rotatable about the shaft part 45B of the bolt 45. Furthermore, the bush 35 is inclinable with respect to the shaft part 45B of the bolt 45 to the extent that the inner peripheral surfaces 35C of both ends thereof having enlarged diameters abut against an outer peripheral surface of the shaft part 45B of the bolt 45. In other words, the damper 10 with the bush 35 attached to the joint 15 is rotatable about the shaft part 45B of the bolt 45 and swingable in a direction intersecting the rotation direction. More specifically, the damper is swung due to the dimensional allowance and the enlarged diameters of the inner peripheral surfaces 35C. Furthermore, by the elastic deformation of the bush 35, the damper 10 can be swung more largely in the direction intersecting the rotation direction.

The slip preventing part 37 is made of rubber, for example, than the outer shape of the base body 31 (a rectangular shape), and is substantially fiat in shape, as illustrated in FIGS. 1 to 4. In the first base 30A placed in abutment on the top surface of the furniture F, the slip preventing part 37 is fitted in a lower opening of the base body 31. In more detail, in the slip preventing part 37, a surface which abuts against the top surface of the furniture F or the ceiling C is flat, and an oppositely directed surface (the surface opposed to the base body 31) is formed with a fitting groove according to an outer peripheral wall of the base body 31 and the ribs R1 and R2. The slip preventing part 37 is detachably attached to the base body 31 by an elastic force thereof.

At the portions where the damper 10 and the bases 30A and 30B are coupled, the bushes 35 are respectively rotatable in FIG. 3. Both ends of the damper 10 are respectively coupled to the bases 30A and 308 so as to be rotatable about the rotation axes. Both ends of the bush 35 have the inner peripheral surfaces 35C the diameters of which are outwardly enlarged. Accordingly, the bush 35 is inclinable relative to the rotation axis to the extent that the inner peripheral surfaces 35C of both ends thereof having enlarged diameters abut against the outer peripheral surface of the shaft part 45B of the bolt 45. More specifically, the bush is swung due to the dimensional allowance and the enlarged diameters of the inner peripheral surfaces 35C. Furthermore, the bush 35 is an elastic body and by the elastic deformation thereof, the damper 10 can be swung more largely in a direction intersecting the rotation direction. Thus, the damper 10 coupled to the bases 30A and 30B is swingable in the direction intersecting the rotation direction.

The fall preventing part 50 is formed by bending a flat band-shaped metal, or formed of a resin, as illustrated in FIGS. 1, 4, and 5. The fall preventing part 50 has a constant width that is slightly smaller than that of the groove 41 formed in the base body 31. In other words, the width of the fail preventing part 50 is slightly smaller than a length, of the slit-like locked hole 49 formed in the base body 31. Furthermore, the fall preventing part 50 has a coupling part 51 and a drooping part 53. The coupling part 51 has a locking part 51A formed, by bending one of ends thereof at a right angle. The drooping part 53 is continuous to the other end of the coupling part 51 and perpendicular to the coupling part 51 and extends In the same direction as the locking part 51A. The drooping part 53 of the fall preventing part 50 has a length set so as not to come out from between the wall surface W and the rear surface of the furniture F when the overturn preventing device falls in such a direction that an upper side thereof departs from the wall surface W, as described later. For example, the drooping part 53 has a length of not less than 100 mm below the slip preventing part 37.

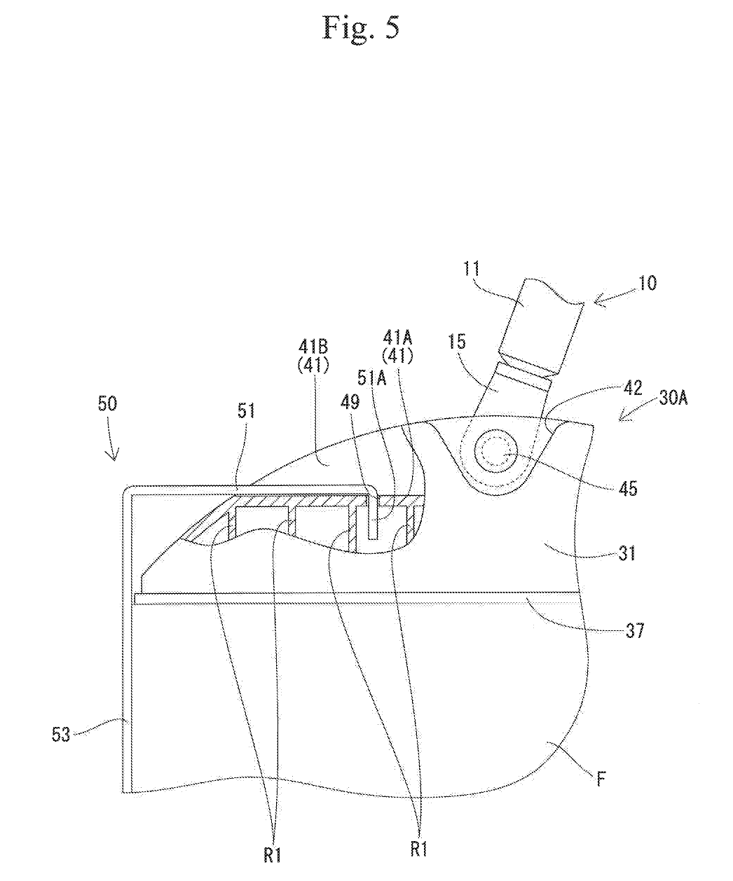

The fall preventing part 50 is attached to the first base 30A placed in abutment on the top surface of the furniture F as illustrated in FIGS. 1 and 5. In more detail, the locking part 51A of the coupling part 51 is inserted and locked in the locked hole 49 of the base body 31 of the first base 30A placed in abutment on the top surface of the furniture F, which locked hole 49 is located at the wall surface W side. Thus, the fall preventing part 50 can be easily attached to the first base 30A in this overturn preventing device. Furthermore, the fall preventing part 50 can be detached from the first base 30A during the packaging of the overturn preventing device or in other cases so that, the overturn preventing device is prevented from bulking.

In a state of being attached to the base body 31 of the first base 30A, the coupling part 51 of the fall preventing part 50 extends along the groove 41 formed in the base body 31 and the other end of the coupling part 51 is located outside an outer edge of the first base 30A (an outer edge of the slip preventing part 37 of the first base 30A). The drooping part 53 droops from the other end of the coupling part 51 and extends downward slightly outside the outer edge of the slip preventing part 37 of the first base 30A. The fall preventing part 50 is disposed between the wall surface W and the rear surface of the furniture F below the first base 30A.

The angle regulator 70 is detachably attached to the first base 30A placed in abutment, on the top surface of the furniture F as illustrated in Figs, 1, 2, and 6. As a result, the angle regulator 70 can be detached from the first base 30A during the packaging of the overturn preventing device or in other cases so that the overturn preventing device is prevented from bulking. In a state of being attached to the first base 30A, the angle regulator 70 has a regulating part 71 which, extends substantially vertically, and a support part 73 which is provided to be continuous from a lower part of the regulating part 71 and prevents the regulating part 71 from being inclined. The rectangular in shape. When the angle regulator 70 is attached to the first base 30A placed in abutment on the top surface of the furniture F, one of short side ends of the regulating part. 71 serves as a receiving part 71A located at an upper end. And, the other short side end is located at a lower end and serves as the insertion part 71B which is inserted into the locked hole 49 of the base body 31 located at the side away from the wall surface W.

The regulating part 71 causes the cylinder 11 of the damper 10 to abut against the receiving part 71A thereby regulating the damper 10 so as not to fall in excess of the inclined state. An inclination angle of the damper 10 preferably ranges from 15°to 25°. The receiving part 71A is upwardly open and curved so as to be downwardly recessed at a central part thereof so that abort one third of the outer periphery of the cylinder 11 abuts thereagainst. Thus, since the cylinder 11 is not held tightly by the receiving part 71A, the movement of the damper 10 is not restrained when the furniture F is tilted, or shaken by shaking of earthquake or the like. In other words, in this overturn preventing device, the damper 10 is rotatable about the rotation axes relative to the bases 30A and 30B and swingable in the direction intersecting the rotation direction, when the furniture F is shaken or tilted by shaking of earthquake or the like.

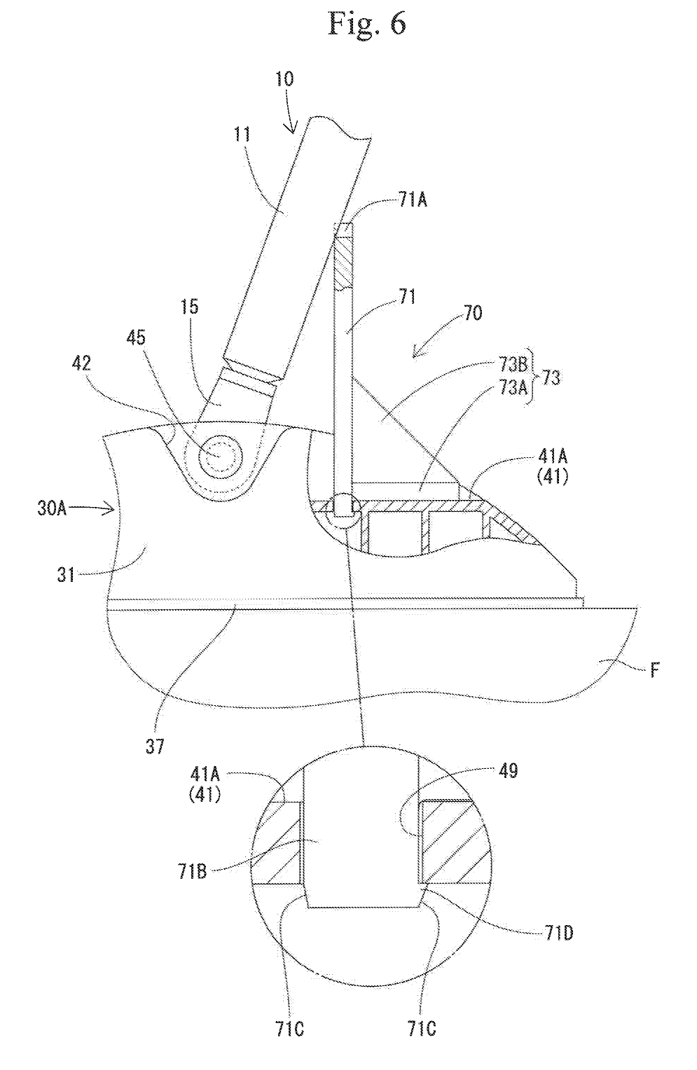

The insertion part 71B has inclined surfaces 71C respectively formed by cutting out both side corners of the short side in the long side direction so as to become thinner toward a distal end thereof, as illustrated in FIG. 6. The inclined surfaces 71C allow the insertion part 71B to be easily inserted into the locked hole 49 of the base body 31. The insertion part 71B also has a protrusion 71D protruding from one of sides of the distal end in the short side direction. The angle regulator 70 is detachable from the first base 30A. However, when a force acts on the angle regulator 70 in such a direction that the insertion part 7B is accidentally pulled out of the locked hole 49 of the base body 31, the protrusion 71D is caught by the locked hole 49, whereby the insertion part 71B is hard to pull out of the locked hole 49.

The support part 73 includes a first support, part 73A and a second support part 73B. The first support part 73A has the same width as the regulating part 71 and is a flat plate extending in a direction perpendicular to the regulating part 71. The first support part 73A abuts against the bottom 41A of the groove 41 formed in the base body 31 when the insertion part 71B of the regulating part 71 is inserted into the locked hole 49 of the base body 31 of the first base 30A. The second support part 73B is a flat plate which has an isosceles right triangle shape and is coupled to a corner between the first support part 73A and the regulating part 71. In more detail, the second support part 73B has two sides having an equal length which are respectively coupled to a side surface of the first support part. 73A and a side surface of the regulating part 71, thereby supporting the regulating part 71 so that the first support part 73A and the regulating part 71 are perpendicular to each other.

Next, the fixing cord 119 will be described. The overturn preventing device 1 is provided with the fixing cord 190 which holds the damper 10 in a contracted state in which the damper 10 has a desired length, as illustrated in FIG. 7. The fixing cord 190 is a member regulating an increase in the distance between the bases 30A and 303, and holds the damper 10 in the contracted state with the desired length when attached to the bases 30A and 30B as illustrated in FIG. 7. The fixing cord 190 includes a band member 110 formed of a resin material or the like and a coupling part 120 at the article side which includes a string made of a chemical fiber or the like. The band member 110 and the coupling part 120 are coupled to each other, thereby constituting the fixing code 190.

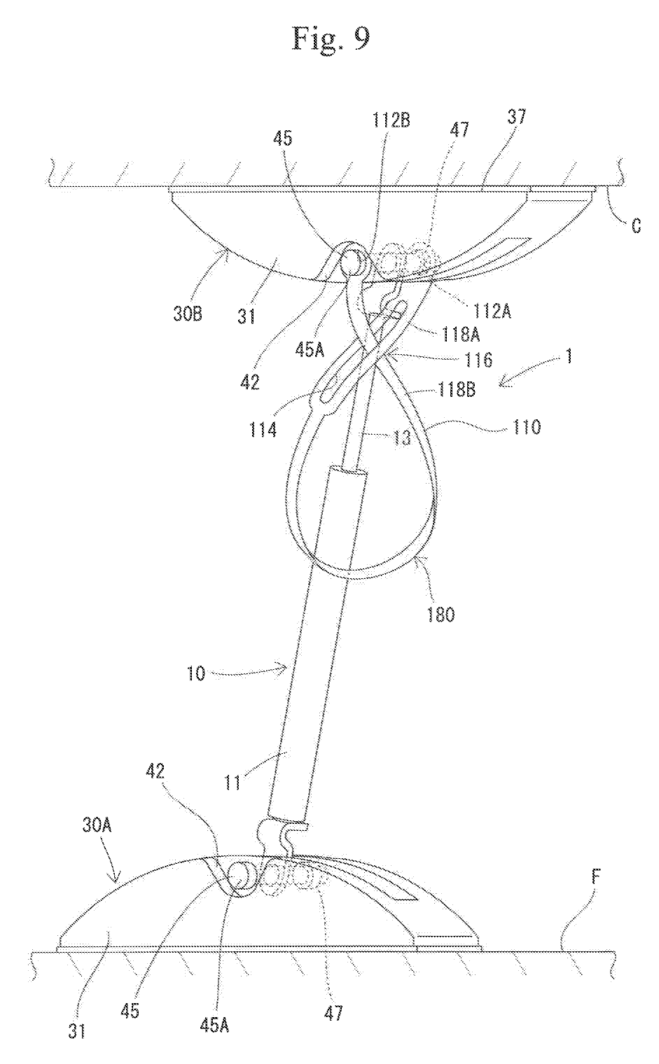

The band member 110 serves as an example of the grip member and includes locking hole parts 112A and 112B serving as locking parts locked to the ceiling side second base 30B as illustrated in FIGS. 7 to 9. Furthermore, the band member 110 includes a grip part 180 which is connected to the parts constituting the locking hole parts 112A and 112B and droops below the second base 30B in the mounted state in which the second base 30B is in abutment against the ceiling C, as illustrated in FIG. 9.

As described above, the second base 30B located at the ceiling side includes a base body 31 serving as an example of the body, and a rotating shaft member (a bolt 45 and a nut 47) which is assembled to the base body 31 and rotatably holds the end of the damper 10. The head 45A of the bolt 45 and the nut 47 respectively serving as both ends of the rotating shaft member respectively protrude at both sides of the central axis of the damper 10 along the direction intersecting with the central axis of the damper 10. Here, the central axis of the damper 10 designates a center line serving as a center of an axis of the rod 13 and its extended line, and the head 45A of the bolt 45 and the nut 47 protrude in a direction perpendicular to the central axis. As illustrated in FIG. 7, the head 45A of the bolt 45 and the nut 47 are respectively inserted into the paired locking hole parts 112A and 112B of the band member 110 so that the paired locking hole parts 112A and 112B are locked to the head 45A of the bolt 45 and the nut 47 while being fitted therewith.

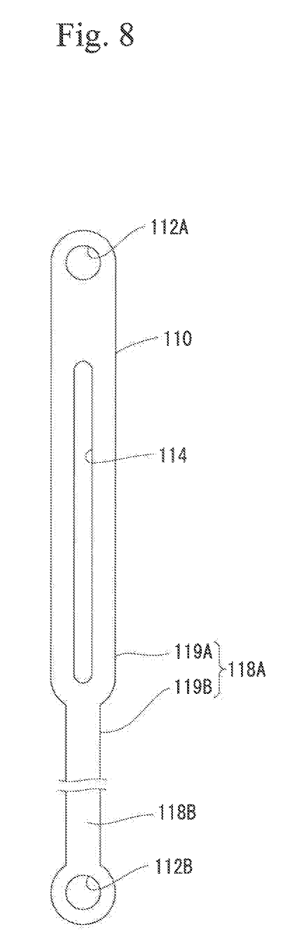

The band member 110 is made of an elastically deformable and more specifically, a resin material such as polypropylene, or the like. The band member 110 is formed into a band member which is elongated in an extended state and has a thin plate shape with a predetermined thickness as illustrated in FIG. 8. The band member 110 is configured to be easily flexible but has a suppressed stretchability. The band member 110 is formed with the locking hole part 112A serving as a hole part located near longitudinal one end thereof and penetrating therethrough in the thickness direction, and the locking hole part 112B serving as a hole part located near the longitudinal other end thereof and penetrating therethrough in the thickness direction. The band member 110 is formed with an elongated hole part 114 located at the longitudinal one side and nearer the longitudinal center than the locking hole part 112A. The elongated hole part 114 penetrates through the band member 110 in the thickness direction and is elongated in the longitudinal direction of the band member 110, In the band member 110, a connecting part 118A is a part located nearer the locking hole part 112A side than a longitudinal center position of the band member 110, and a connecting part 118B is a part located nearer the locking hole part 112B side than the longitudinal center position of the band member 110. The connecting part 118A has a larger width part 119A having a relatively larger width and a smaller width part 119B having a relatively smaller width. The larger width part 119A is formed with the elongated hole part 114. The connecting part 118B is formed into a relatively smaller width part, and more specifically, the connecting part 118B has a width that is the same as that of the smaller width part 119B and is substantially constant from near the locking hole part 112B to the longitudinal center position of the band member 110.

When the band member 110 is to be fixed to the second base 30B as illustrated in FIGS. 7 and 9, the end of the band member 110 at the longitudinal one side (the end at the locking hole part 112B side) is caused to enter the elongated hole part 114 from the extended state as illustrated in FIG. 8, and the caused to pass through the elongated hole part 114. As a result, the connecting part 118B connected to the locking hole part 1123 and the connecting part 118A connected to the locking hole part 112A are caused to intersect with each other. In this intersecting state, there is formed an intersecting part 116 in which a part of the connecting part 118A constituting the elongated hole part 114 intersects with the connecting part 118B. The intersecting part 116 serves as an example of a narrowed part, which is a part where the connecting parts 118A and 118B respectively connected to the locking hole parts 112A and 112B are caused to come close to each other so that a distance therebetween is shorter than the distance between the locking hole parts 112A and 112B.

In the intersecting state of the band member 110 in which the connecting part 118B is passed, through the elongated hole part 114, the locking hole part 112A is fitted with the nut 47 thereby to be locked, and the locking hole part 112B is fitted with the head 45A of the bolt 45 thereby to be locked. Thus, the band, member 110 is attached to the second base 30B in the intersecting state.

The grip part 130 is formed into an annular shape while located below the intersecting part 16 (the narrowed part) in against the ceiling C. A center side part of the band member 110 when the band member 110 is extended into an elongated shape as illustrated in FIG. 8 serves as the annular grip part 180 when in the intersecting state as illustrated in FIG. 9. The grip part 180 is a part gripped to be operated by a worker in the mounted state as illustrated in FIGS. 1 and 9.

The coupling part 120 of the fixing cord 190 at the article side is disposed so as to couple the annular part (the grip part 180) of the band member 110 disposed in the intersecting state and the first base 30A, as illustrated in FIG. 7. The coupling part 120 at the article side is formed of a string made of a chemical fiber or the like and is attached so that the grip part 180 of the band member 110 is pulled downward. The length of the damper 10 in the contracted state and the distance between the bases 30A and 40B can be determined by adjusting the length of the coupling part 120 at the article side. In other words, the damper 10 can be maintained in a longer state when the distance between a contact portion of the coupling part 120 caught by the grip part 180 and the rotating shaft member (the bolt. 45 and the nut 47) of the first base 30A is rendered longer. In an opposite manner, the damper 10 can be maintained in a shorter state when the distance between the contact portion and the rotating shaft member (the bolt 45 and the nut 47) is rendered shorter.

The following will describe a manner of mounting the overturn preventing device 1. In the overturn preventing device 1 constructed, as described above, the damper 10 can be held in the contracted state by the fixing cord 190 in advance. After the overturn preventing device 1 has been placed on the top surface of the furniture F with the damper 10 being held in the contracted state as illustrated in FIG. 7, the coupling part 120 at the article side is loosened or cut. Thereupon, the damper 10 is extended by an expansion force of the compressed gas enclosed in the cylinder 11, so that the second, base 30B abuts against the ceiling C as illustrated in FIGS. 1 and 9. Thus, when the overturn preventing device 1 is to be mounted, the worker need not do the work to contract the damper 10 above the furniture F, with the result that the overturn preventing device 1 can easily be mounted between the top surface of the furniture F and the ceiling C.

When the overturn preventing device 1 has been mounted between the ceiling C and the furniture F, the band member 110 forming a part of the fixing cord 190 droops from the second base 30B, as illustrated in FIGS. 1 and 3. In this case, the annular grip part 180 is disposed below the intersecting part 116 in the band member 110.

In the case where the overturn preventing device 1 is mounted between the ceiling C and the furniture F as illustrated in FIGS. 1 and 9, the mounting work can be finished if the second base 30B abuts against the ceiling C at a desired location. In this case, the band, member 110 may be detached from the second base 30B or may remain attached to the second base 30B.

On the other hand, if the second base 30B is not in contact 20 with the ceiling C at a desired location in the mounted state and 9 and needs to be relocated, the worker, for example, pulls the annular grip part 180 downward while holding the grip part 180. When the grip part 180 is pulled downward against the biasing 25 force of the damper 10, the second base 30B can be moved downward thereby to be detached from the ceiling C, with the result that the second base 30B can be made into a state where no frictional force is generated between the second base 30B and the ceiling C. Thus, the second base 30B can be moved to the desired location by moving the grip part 180 back and forth or right and left while being detached from the ceiling C. When the pull of the grip part 180 is finished at a desired location, the second base 30B abuts against the ceiling C near the desired location thereby to be positioned.

As described above, when the overturn preventing device 1 is mounted so that the first base 30A abuts against the top surface of the furniture F (the article) and the second base 30B abuts against the ceiling C, the locking hole parts 112A and 112B of the band member 110 are locked to the second base 30B. In this locked state, the grip part 180 connected to the locking hole parts 112A and 112B droops below the second base 30B. Since the overturn preventing device 1 is thus constructed, when having a desire to change the location of the second base 30B, the worker can easily detach the second base 30B from the ceiling C against the biasing force of the damper 10 by pulling the grip part 180 downward while gripping the grip part 180 drooping downwardly. The second base 30B can be moved to the desired location by moving the grip part 180 while a frictional force is prevented from being generated by the above-described pulling operation. In particular, when the location of the ceiling side base is to be changed, the worker can operate a portion located nearer than the second base 30B, and moreover, the worker can operate while gripping the drooping grip part 18. As a result, the worker can easily do the work in a posture allowing the worker to apply a strong force.

Accordingly, according to the band member 110, the second base 303 located at the ceiling side can easily be relocated even after the overturn preventing device 1 has been mounted between the top surface of the furniture F (the article) and the ceiling C.

The second base 30B located at the ceiling side includes the base body 31 (the body) and the bolt 45 and the nut 47 (the rotating shaft member) which are assembled to the base body 31 and rotatably hold the end of the damper 10. The head 45A of the bolt 45 and the nut 47 respectively protrude at both sides of the central axis of the damper 10 along the direction intersecting with the central axis of the damper 10. The paired locking hole parts 112A and 112B (locking parts) of the band member 110 are locked to the head 45A of the bolt 45 and the nut 47 respectively. Thus, in the case where the paired locking hole parts 112A and 112B respectively locked to both ends of the rotating shaft member, when the grip part 180 connected to the locking hole parts 112A compression of the damper 10. Accordingly, the pull force applied to the grip part 180 required, to detach the ceiling side second base 30B from the ceiling can be reduced more, with the result that the relocation operation can be carried out more easily.

The band member 110 includes the connecting parts 118A and 118B connected to the respective locking hole parts 112A and 112B, and the connecting parts 118A and 118B are caused to come close to each other so that a distance therebetween is shorter than a distance between the paired locking hole parts 112A and 112B, thereby forming the intersecting part 116 (the narrowed part). The grip part 180 is formed into an annular shape while located below the intersecting part 116, in the mounted state in which the ceiling side base is in abutment, against the ceiling. When the grip part 180 is thus formed into an annular shape, the worker can easily grip the grip part 180 and easily apply the downward pull force. Furthermore, the intersecting part 116 (the narrowed part) is located between the paired locking hole parts 112A and 112B and the grip part 180 in the mounted state in which the ceiling side base is in abutment against the ceiling. Accordingly, when the grip part 180 is pulled downward, the locking hole parts 112A and 112B are subjected not only to the downward force but also to a force applied in the direction such that the locking hole parts 112A and 112B come close to each other. As a result, the paired locking hole parts 112A and 112B are rendered less likely to be detached outwardly from the head 45A of the bolt 45 and the nut 47 (both ends of the rotating shaft member).

The band member 110 is made of the elastically deformable material and formed into an elongated shape in the extended state. The band member 110 is formed with the one locking hole part 112A at a location near the longitudinal one end and formed with the other locking hole part 112B at a location near the longitudinal other end. The band member 110 is also formed with the elongated hole part 114 (the through hole part) located between the locking hole parts 112A and 112B. The band member 110 is attached to the second base 30B in the intersecting state such that the connecting part 118B is passed through the elongated hole part 114. According to this configuration, the annular grip part 180 which is easy to grip can be constructed with the simple structure such that the locking hole parts 112A and 112B are respectively formed near both ends of the elastically deformable elongated material and the elongated hole part 114 (the through hole part) is formed therebetween. Furthermore, the paired locking hole parts 112A and 112B can be rendered less likely to be detached.

### Second Embodiment

Next, the overturn preventing device of a second embodiment will be described. A structure in which the article side coupling part 120 is eliminated from the overturn preventing device 1 of the first embodiment can be adopted as a configuration of the overturn preventing device of the second embodiment. The overturn preventing device of the second embodiment differs from, the overturn preventing device 1 of the first embodiment in that the article side coupling part 120 is eliminated and is the same in the other respects as the overturn preventing device 1 of the first embodiment.

In other words, the construction of the overturn preventing device of the second embodiment is the same as that illustrated in FIG. 9. Therefore, the construction will be described with reference to FIG. 9 for descriptive purposes. The overturn preventing device as illustrated in FIG. 9 has no function of holding the damper 10 in the contracted state by the fixing cord.

When the overturn preventing device described above is to be mounted between the furniture F and the ceiling C, the paired bases 30A and 30B are moved in the approaching direction against, the biasing force of the damper 10 by one or more workers so that the damper 10 is put into the contracted state. While the damper 10 is maintained in the contracted state, the first base 30A is placed on the top surface of the furniture F, and the second base 30B is moved near a desired location on the ceiling C. Then, the bases 30A and 30B are caused to depart from each other so that the damper 10 is extended, with the result that the second base 30B can be caused to abut against the ceiling C. In this case, too, if the second base 30B is not in contact with the ceiling C at a desired location and needs to be relocated, the grip part 180 can be operated in the same manner as in the first embodiment.

### Third Embodiment

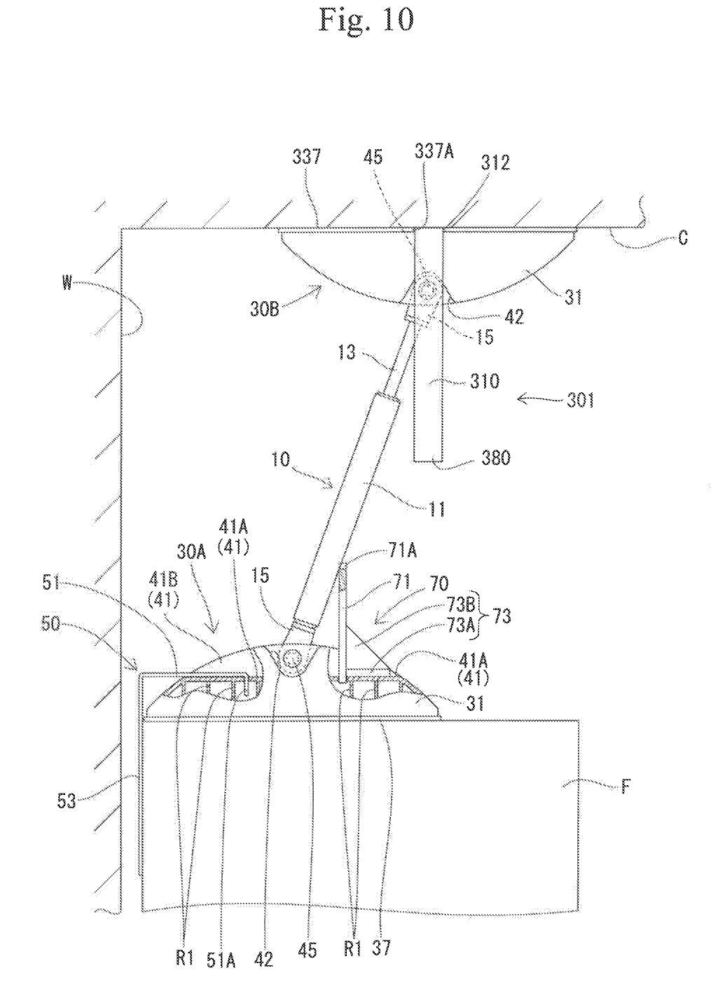

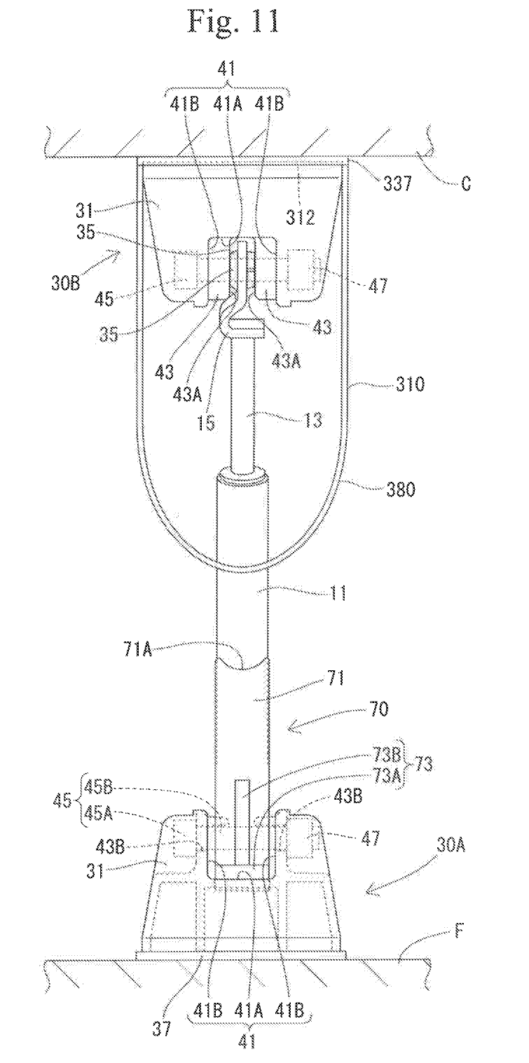

The overturn preventing device of a third embodiment will be described with reference to FIGS. 10, 11 and so on. The overturn preventing device 301 of the third embodiment differs from that of the first embodiment in that the fixing cord 190 has been changed to a band member 310 and that the slip preventing part 37 has been changed to a slip preventing part 337 formed with a groove 337A. The overturn preventing device 301 is the same as that of the first embodiment in the other respects. Accordingly, identical or similar parts in the third embodiment are labelled by the same reference symbols as those in the first embodiment and detailed description of these parts will be eliminated.

The overturn preventing device 301 also includes the damper 10 mounted between the top surface of the furniture F and the ceiling C and the paired bases 30A and 30B respectively coupled to both ends of the damper 10.

The band member 310 serving as an example of the grip member has a configuration such that a band-shaped member with a predetermined width and a predetermined thickness is formed into an annular shape. The band member 310 is made of an elastically deformable material, more specifically, a resin material such as polypropylene, or the like.

The slip preventing part 337 provided on the second base 30B is formed with a groove 337A extending in the short side direction and located near the central part of the second base 308 in the long side direction. A part of the band member 310 is disposed so as to be caught on the base body 31 while being housed in the groove 337A. A locking part 312 in the band member 310 which is a part disposed in the groove 337A may be fixed to the base body 31 by sticking, fixing by a fastening member such as screws, and the like, or may not be fixed.

The grip part 380 is a part gripped to be operated by a worker in the mounted state as illustrated in. FIGS. 10 and 11. The grip part 380 droops below the second base 30B in the mounted state in which the second base 30B id in abutment against the ceiling C. The grip part 380 is formed into an annular shape so as to be connected to one and the other sides of the second base 30B in the sort, side direction.

The overturn preventing device 301 constructed as described above can also be mounted in the same manner as that of the second embodiment, and the location of the second base 30B can be adjusted in the same manner as those of the first and second embodiments after the mounting.

Although the annular band member 310 is caught in the groove 337A in the example of FIGS. 10 and 11, it should not be limited to this example. For instance, the base body 31 may be formed with a hole extending in the short side direction, and the band member 310 may extend through the hole thereby to be caught in the hole.

### Fourth Embodiment

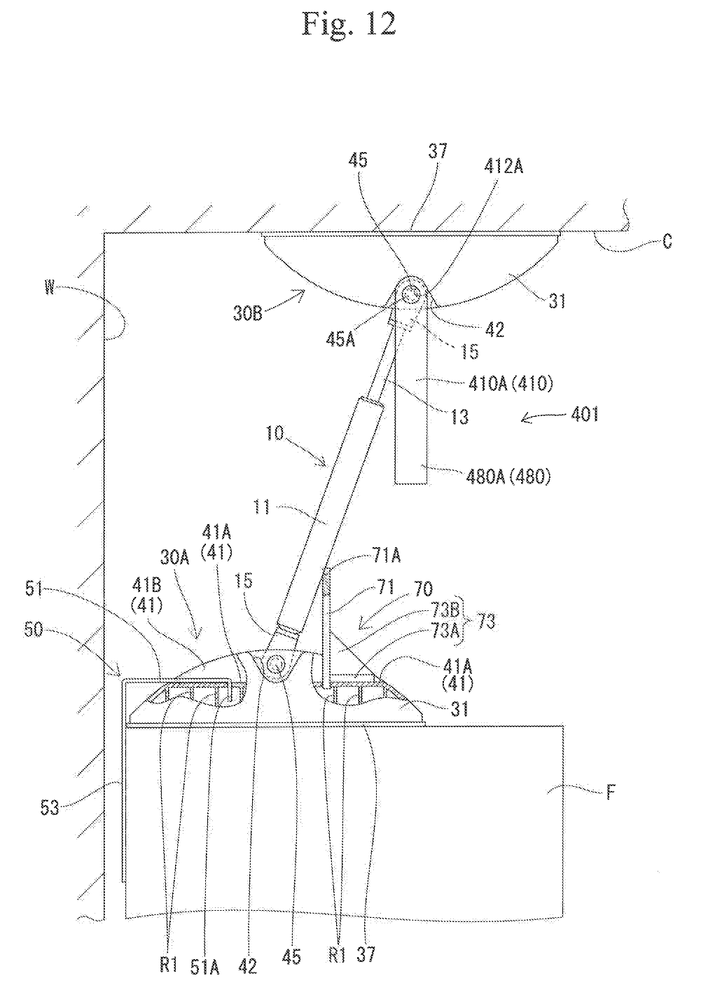

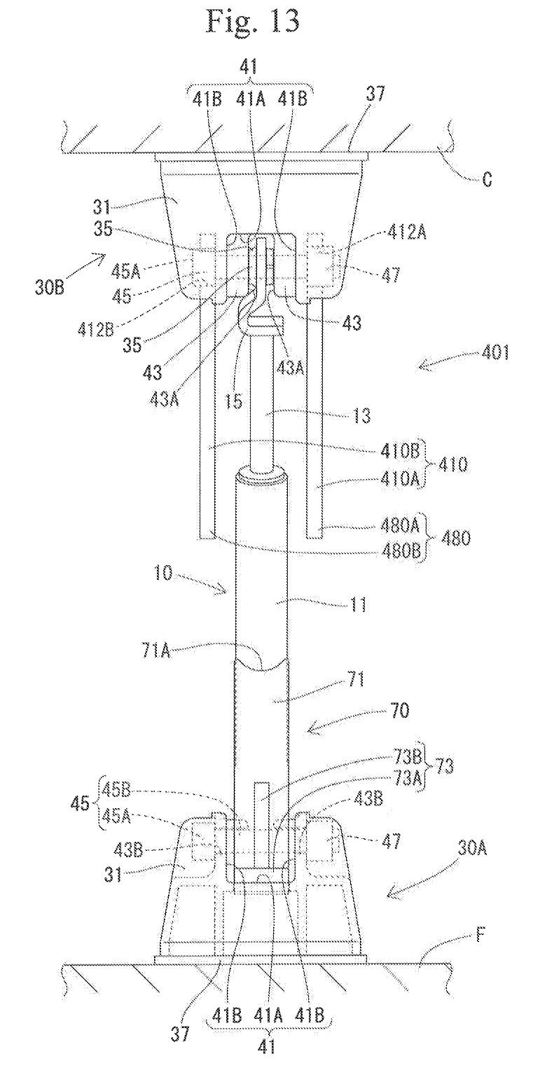

The overturn preventing device of a fourth embodiment will be described with reference to FIGS. 12, 13 and so on. The overturn preventing device 401 of the fourth embodiment differs from that of the first embodiment only in that the fixing cord 190 has been changed to a band member 410 and is similar to the first embodiment in the other respects. Accordingly, identical or similar parts in the fourth embodiment are labelled by the same reference symbols as those in the first embodiment and detailed description of these parts will be eliminated.

The overturn preventing device 401 also includes the damper 10 mounted between the top surface of the furniture F and the ceiling C and the paired bases 30A and 30B respectively coupled to both ends of the damper 10. The second base 30B located at the ceiling side includes the base body 31 (the body), and the bolt 45 and the nut 47 (the rotating shaft member) which are assembled to the base body 31 and rotatably hold the end of the damper 10. Both ends of the assembly of the bolt 45 and the nut 47 protrude at both sides of the central axis of the damper 10 along the direction intersecting with the central axis of the damper 10.

The band member 410 includes a first band member 410A and a second band member 410B as illustrated in FIG. 13. The first band member 410A is made of an elastically deformable material such as polypropylene and formed into a band shape. The first band member 410A is formed with a locking hole part 412A penetrating through a part near a longitudinal one end thereof. The second band member 410B is also made of the elastically deformable material such as polypropylene and formed into the band shape. The second band member 410B is formed with a locking hole part 412B penetrating through a part near a longitudinal one end thereof. The locking hole part 412A of the first band member 410A is fitted with the nut 47 thereby to be locked to the nut 47. In the mounted state as illustrated in FIGS. 12 and 13, a part of the first band member 410A connected to the locking hole part 412A is disposed so as to droop below the nut 47. The locking hole part 412B of the second band member 410B is fitted with the head 45A of the bolt 45 thereby to be locked to the head 45A. In the mounted state as illustrated in FIGS. 12 and 13, a part of the second band member 410B connected to the locking hole part 412B is disposed so as to droop below the head 45A. A grip part 400 is constituted by a first grip part 480A extending from, the locking hole part 412A of the first band member 410A and a second grip part 480B extending from the locking hole part 412B of the second band member 410B.

The overturn preventing device 401 constructed as described above can also be mounted in the same manner as that of the second embodiment, and the location of the second base 30B can be adjusted in the same manner as those of the first, to third embodiments after the mounting. In the above-described construction, for example, the second base 30B may be moved by griping both first and second grip parts 480A and 480B with one hand or by griping the first and second grip parts 480A and 480B respectively with both hands.

### Fifth Embodiment

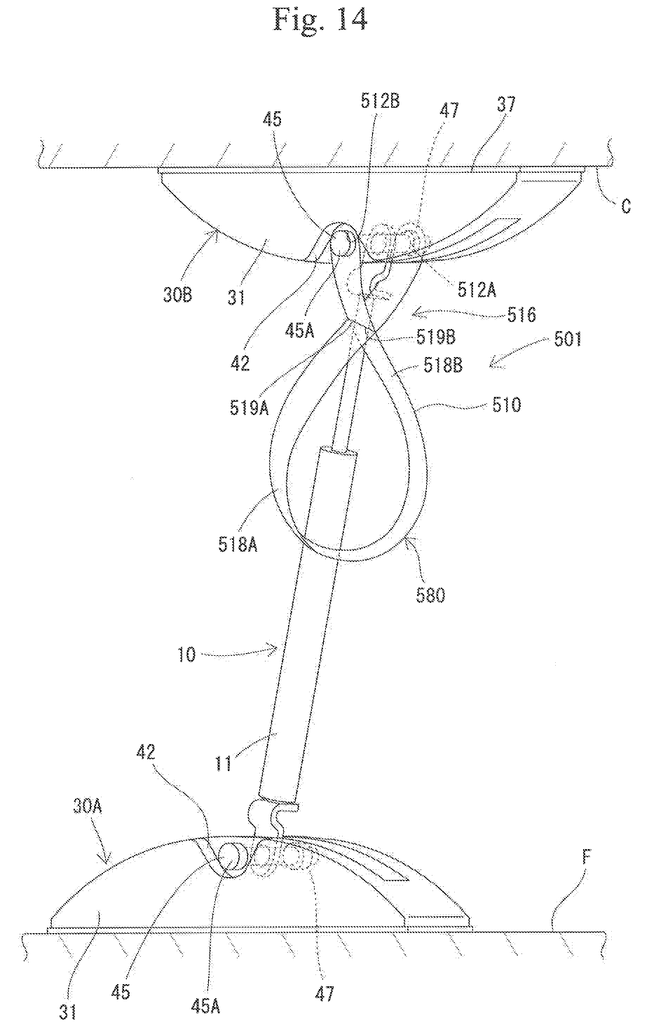

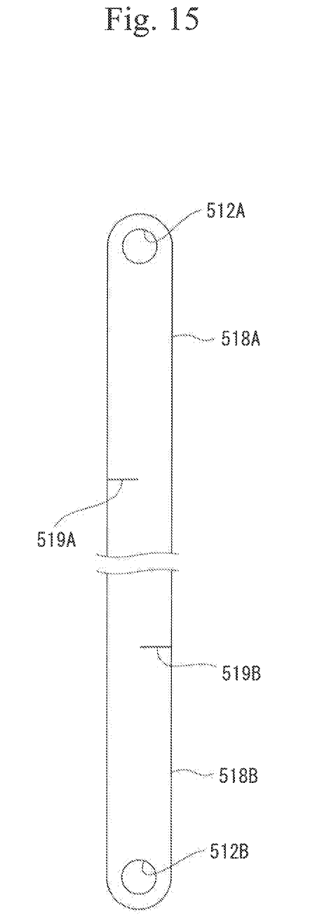

The overturn preventing device of a fifth embodiment will be described with reference to FIGS. 14, 15 and so on. The overturn preventing device 501 of the fifth embodiment differs from that of the first embodiment only in that the fixing cord 190 has been changed to a band member 510 and is similar to the first embodiment in the other respects. Accordingly, identical or similar parts in the fifth embodiment are labelled by the same reference symbols as those in the first embodiment and detailed description of these parts will be eliminated.

The overturn preventing device 501 also includes the damper 10 mounted between the top surface of the furniture F and the ceiling C and the paired bases 30A and 30B respectively coupled to both ends of the damper 10. The second base 30B located at the ceiling side includes the base body 31 (the body), and the bolt 45 and the nut 47 (the rotating shaft member) which are assembled to the base body 31 and rotatably hold the end of the damper 10. Both ends of the assembly of the bolt 45 and the nut 47 protrude at both sides of the central axis of the damper 10 along the direction intersecting with the central axis of the damper 10.

The band member 510 is made of a resin material such as polypropylene, or the like, and formed as a band, member which is elongated in an extended state and has a thin plate shape with a predetermined thickness as illustrated in FIG. 15. The band member 510 is configured to be easily flexible but has a suppressed stretchability. The band member 510 is formed with the locking hole part 512A serving as a hole part located near the longitudinal one end thereof and penetrating therethrough in the thickness direction and the locking hole part 512B located near the longitudinal other end thereof and penetrating therethrough in the thickness direction. The band member 510 has a cut 519A formed at the longitudinal one side and at a location nearer the longitudinal center than the locking hole part 512A. The cut 513A is formed by partially cutting the band member 510 in a widthwise direction. The band member 510 has a cut 519B formed at a location nearer the longitudinal center than the locking hole part 512B. The cut 519B is formed by partially cutting the band member 510 in a widthwise direction. The connecting part 518A is a part located nearer the locking hole part 512A side than the longitudinal center position of the band member 510, The connecting part 518B is a part located nearer the locking 15 hole part 512B side than the longitudinal center position of the

When the band member 510 is to be fixed to the second base 30B as illustrated in FIG. 14, the cuts 519A and 519B are engaged with each other from, the extended state as illustrated in FIG. 15. As a result, the connecting part 5183 connected to the locking hole part 512B and the connecting part 518A connected to the locking hole part 512A are caused to intersect with each other. In this intersecting state, an intersecting part 516 is formed by a part in which the cuts 519A and 519B are engaged with each 25 other. The intersecting part 516 serves as an example of narrowed part, which is a part where the connecting parts 518A and 518B respectively connected, to the locking hole parts 512A and 512B are caused to come close to each other so that a distance therebetween is shorter than the distance between the locking hole parts 512A and 512B.

In the intersecting state of the band member 510 as illustrated in FIG. 14, the locking hole part 512A is fitted with the nut 47 thereby to be locked, and the locking hole part 512B is fitted with the head 45A of the bolt 45 thereby to be locked. Thus, the band member 510 is attached to the second base 30B in the intersecting space.

The grip part 580 is formed into an annular shape while located below the intersecting part 516 (the narrowed part) in the mounted state in which the second base 30B is in abutment against the ceiling C. A center side part of the band, member 510 in the state where the band member 510 is extended into an elongated shape as illustrated in FIG. 15 serves as the annular grip part 580 when in the intersecting state as illustrated in FIG. 14. The grip part 500 is a part gripped to be operated by a worker in the mounted state as illustrated in FIG. 14.

The overturn preventing device 501 constructed as described above can also be mounted in the same manner as those of the second to fourth embodiments, and the location of the second base 30B can be adjusted, in the same manner as those of the first to fourth embodiments after the mounting.

A coupling part 120 similar to that in the first embodiment may be attached to the above described band member 510, thereby having the same function as the fixing cord 190 in the first embodiment.

### Sixth Embodiment

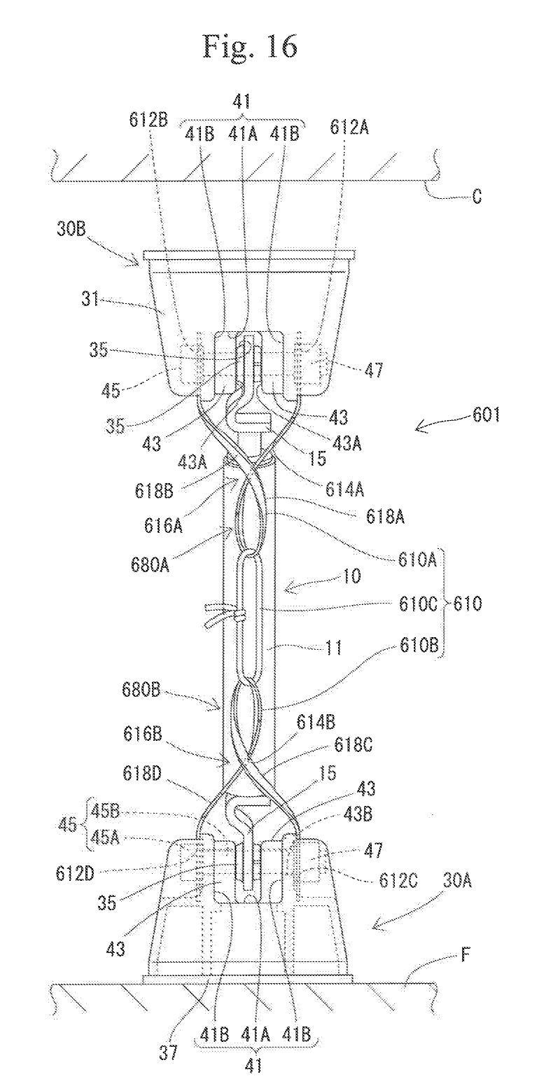

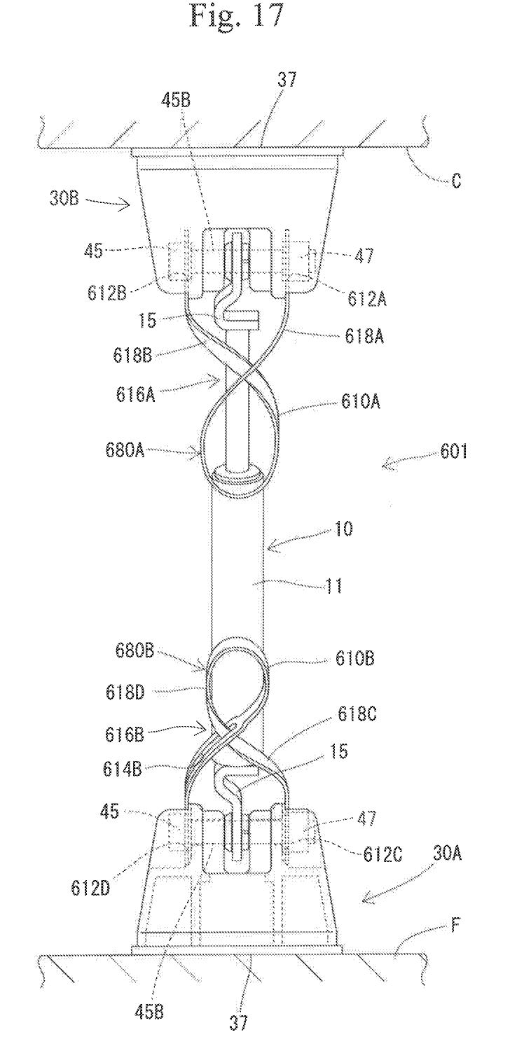

The overturn preventing device of a sixth embodiment will be described with reference to FIGS. 16, 17 and so on. The overturn preventing device 601 of the sixth embodiment differs from that of the first embodiment in that the fixing cord 190 has been changed to 5 fixing cord 610 and is similar to the first embodiment in the other respects. Accordingly, identical or similar parts in the sixth embodiment are labelled by the same reference symbols as those in the first embodiment and detailed description of these parts will be eliminated. The angle regulator 70 is eliminated in FIGS. 16 and 17.

The overturn preventing device 601 also includes the damper 10 mounted between the top surface of the furniture F and the ceiling C and the paired bases 30A and 30B respectively coupled to both ends of the damper 10. The overturn preventing device 601 is further provided with a fixing cord 610 which holds the damper 10 in the contracted state in which the damper 10 has a desired length. The fixing cord 610 is a member regulating an increase in the distance between the bases 30A and 30B and holds the damper 10 in the contracted state with the desired length when attached to the bases 30 A and 30B as illustrated in FIG. 16. The fixing cord 610 includes band members 610A and 610B each of which is made of a resin material or the like and a coupling member 610C comprising a string made of a chemical fiber or the like. The band members 610A and 610B and the coupling member 610C are coupled to one another, thereby constituting the fixing code 610.

The band members 610A and 610B have the same structure and the same shape in the extended state. The band members 610A and 610B have the same construction as the band member 110 (FIGS. 7, 8 and so on) in the first embodiment. In this regard, however, an overall length of each of the band members 610A and 610B, respective lengths of parts corresponding to a larger width part 119A, a smaller width part 119B, a connecting part 118B and an elongated hole part 114 (FIG. 8) may be set at various values, and these lengths need not be the same as those of the band member 110.

The band member 610A serves as an example of a first attachment member and includes a pair of locking hole parts 612A and 612B serving as locking parts and a grip part 680A. The band member 610A is attached to the second base 30B in the same structure as the band member 110 (FIGS. 7, 8 and so on) and functions in the same manner as the band member 110. More specifically, the locking hole parts 612A and 612B having the same structures as the locking hole parts 112A and 112B (FIGS. 7, 8 and so on) are respectively locked to the nut 47 and the bolt 45 of the second base 30B thereby to be assembled. The band member 610A is formed with an elongated hole part 614A serving as a through hole part, which is located at a position between the locking hole parts 612A and 612B. The band member 610A is attached to the second base 30B in an intersecting state such that a connecting part 618A is passed through the elongated hole part 614A. The connecting part 618A is a part, located nearer the locking hole part 612A side than the longitudinal center position in the extended state of the band member 610A, and a connecting part 618B is a part located nearer the locking hole part 612B side than the longitudinal center position. An intersecting part 616A in which the connecting parts 613A and 618B intersect with each other serves as an example of narrowed part. At the intersecting part 616A, the distance between the connecting parts 618A and 618B is shorter than the distance between the locking hole parts 612A and 612B. The grip part 680A is formed into an annular shape while located below the intersecting part 616A (the narrowed part) in the mounted, state in which the second base 30B is in abutment against the ceiling C as illustrated in FIG. 17.

The band, member 610B serves as an example of a second attachment member. The band member 610B includes locking hole parts 612C and 612D locked to the first base 30A, and a second grip part 680B connected to locking hole parts 612C and 612D. The band member 610 is attached to the first base 30A in the same attachment structure as the band member 610A. More specifically, the locking hole parts 612C and 612D having the same structures as the locking hole ports 112A and 112D (FIG. 0 and so on) serve as an example of the second locking part, and are respectively locked to the nut 47 and the bolt 45 of the first base 30A thereby to be assembled. The band member 610B is formed with an elongated hole part 614B serving as the second through hole part. The band member 610B is attached to the first base 30A in an intersecting state such that a connecting part 618C (the part connected to the locking hole part 612C) is passed through the elongated, hole part 614B. The connecting part 618C is a part located nearer the locking hole part 612C side than the longitudinal center positron in the extended state of the band member 610B. A connecting part 618D is a part located nearer the locking hole part 612D than the longitudinal center position. A second intersecting part 616B in which the connecting parts 618C and 618D intersect with each other functions as a second narrowed, part. At the second intersecting part 616B, the distance between the connecting parts 618C and 618D is shorter than the distance between the locking hole parts 612C and 612D.

The coupling member 610C as illustrated in FIG. 16 couples the band member 610A (the first attachment member) and the band member 610B (the second attachment member). In the example as illustrated in FIG. 16, the coupling member 610C is formed into an annular shape with a part thereof being tied. In the state as illustrated in FIG. 16, the band members 610A and 610B are biased by the damper 10 in the direction separating from each other. The coupling member 610C holds the band members 610A and 610B while pulling the band members 610A and 610B in the direction coming close to each other. As a result, in the contracted state as illustrated in FIG. 16, the band members 610A and 610B are held so that the distance between the ends of the band members 610A and 610B is not increased, beyond a predetermined value. Thus, the band members 610A and 610B and the coupling member 610C are connected between the second base 30B located at the ceiling side and the first base 30A located at the article side, so that the fixing cord 610 (the grip member) holds the damper 10 in the contracted state in which the damper 10 has a desired length.

In the overturn preventing device 601 constructed as described above, the damper 10 can be held in the contracted state by the fixing cord 610 in advance. When to be mounted, the overturn preventing device 601 can be mounted in the same manner as in the first embodiment. For example, the overturn preventing device 601 is placed on the top surface of the furniture F with the damper 10 being held in the contracted state, as illustrated in FIG. 16. Subsequently, the coupling member 610C is loosened or cut, whereby the overturn preventing device 601 can easily be mounted between the top surface of the furniture F and the ceiling C. Since the band member 610A droops from the second base 30B in the mounted state of the overturn preventing device 601, as illustrated in FIG. 17, the second base 30B can easily be relocated by operating the grip part 680A in the same manner as in the first embodiment.

On the other hand, the band member 610B (the second attachment member), which is a part different from the band member 610A, remains attached to the first base 30A as illustrated in FIG. 17. Accordingly, when the first base 30A is to be relocated, it is possible to operate while griping the second grip part 680B of the band member 610B so as to pull up and move the first base 30A. As a result, the work of adjusting the location of the first base 30A disposed at the article side can also be rendered easier.

The band member 610A (the first attachment member) remains attached to the second base 30B as illustrated in FIG. 17 after the overturn preventing device 601 has been mounted by loosening or cutting the coupling member 610C. The band member 610B (the second attachment member) remains attached to the first base 30A. Accordingly, the overturn preventing device 601 can be set again into the contracted state by coupling the band members 610A and 61B so as to come close to each other using the coupling member 610C (FIG. 16) or a new member. In other words, the mounting work in reinstallation of the overturn preventing device 601 can also be rendered easier.

The present invention should, not be limited to the embodiments described above with reference to the drawings, but the technical scope of the invention encompasses the following embodiments, for example.

(1) Although the overturn preventing device is mounted on the furniture in each of the first to sixth embodiments, the overturn preventing device may be mounted on an article such as a bookshelf or a refrigerator which has a possibility of overturn by shaking of earthquake or the like.
(2) Although the overturn preventing device is mounted on the furniture installed on the floor with its rear surface being opposed to the wall surface in each of the first to sixth embodiments, the overturn preventing device may be mounted on the furniture or the like installed on the floor without being adjacent to the wall surface.
(3) In each of the first to sixth embodiments, both ends of the damper are respectively coupled to the bases so as to be rotatable about the rotation axes and swingable in the direction intersecting the rotation direction. However, both ends of the damper may not be respectively coupled to the bases so as to be rotatable or swingable.
(4) Although the compression damper is used in each of the first to sixth embodiments, a two-way damper may be used as long as it can exert a predetermined damping force in a contracting operation.
(5) Although the damper enclosing a hydraulic fluid and a compressed gas in the cylinder is used in each of the first to sixth embodiments, a fluid-pressure damper enclosing another fluid or another type of damper may be used as long as it can exert a predetermined damping force in a contracting operation.
(6) In each of the first to sixth embodiments, the compressed gas is enclosed in the cylinder so that an expansion force of the compressed gas acts in an extension direction. However, a force acting in the extension direction may be generated by another manner.
(7) Although the overturn preventing device includes the fall preventing part in each, of the first, to sixth embodiments, the overturn preventing device may not include the fall preventing part. Furthermore, the fall preventing part may be formed integrally with the first base.
(8) Although the overturn preventing device includes the angle regulator in each of the first to sixth embodiments, the overturn, preventing device may not include the angle regulator. Furthermore, although the angle regulator is detachably attached to the first base in the first embodiment, the angle regulator may be formed integrally with the first base or the cylinder of the damper.
(9) Although the elongated hole part 114 is presented as the through, hole part in the first embodiment and the elongated hole part 614A is presented as the through hole part in the sixth embodiment, these through hole parts may not be elongated. The through hole parts may be circular, elliptic, rectangular or the like. Similarly, although the elongated hole part 614B is presented as the second through hole part in the sixth embodiment, the through hole part may not be elongated but may be circular, elliptic, rectangular or the like.

(10) Although the intersecting part in which the connecting parts intersect with each other is presented as the narrowed part in each of the first, fifth and sixth embodiments, the narrowed part should not be limited to the disclosed examples. For example, the connecting parts may be fixed together or bundled by a separate member with narrow space therebetween. The same may apply to the second intersecting part in the sixth embodiment.

(11) The grip member configured as the band member is exemplified in each of the first to fifth embodiments, and the first attachment member configured as the band member is exemplified in the sixth embodiment. However, a part or an entire part of each of them may not be configured as the band member as long as it droops from the ceiling side base and a part of it is configured as the grip part. For example, instead of the band member of each of the first to fifth embodiments or the first attachment member in the sixth embodiment, a string-like member having a similar function may be used, or some part may be formed into a string-like or band-like shape having flexibility and the other part may be formed to have a higher stiffness.

(12) Although the second attachment member configured as the band member is exemplified in the sixth embodiment, a part or an entire part of the second attachment member may not be configured as the band member. For example, a string-like member having a similar function may be used, or some part may be formed into a string-like or band-like shape having flexibility and the other part may be formed to have a higher stiffness.

(13) Although the coupling member 610C configured as a string is exemplified in the sixth embodiment, another member may be used as long as the member can couple the first and second attachment members while pulling the first and second attachment members, and various materials such as metal materials or resin materials may be used. For example, the coupling member may be a band-shaped member or may be formed of a metal material such as a wire.

### EXPLANATION OF REFERENCE SYMBOLS

C . . . ceiling; F . . . furniture (article); 1, 301, 401, 501, 601 . . . overturn preventing device; 10 . . . damper; 30A, 30B . . . base (30A . . . first base, 30B . . . second base); 31 . . . base body (body); 45, 47 . . . rotating shaft member (45 . . . bolt, 47 . . . nut); 110, 310, 410, 510 . . . band member (grip member); 112A, 112B, 412A, 412B, 512A, 512B, 612A, 612B . . . locking hole part (locking part); 114, 614A . . . elongated hole part (through hole part); 116, 516, 616A . . . intersecting part (narrowed part); 110A, 110B, 510A, 510B, 618A, 61B . . . connecting part; 180, 380, 480, 580, 680A . . . grip part; 190 . . . fixing cord; 312 . . . locking part; 610 . . . fixing cord (grip member); 610A . . . band member (first attachment member); 610B . . . band member (second attachment member); 610C . . . coupling member; 612C, 612D . . . locking hole part (second locking part); and 680B . . . second grip part.

1. A grip member for an overturn preventing device including a damper to be mounted between a top surface of an article installed on an installation surface and a ceiling, and a pair of bases respectively coupled to both ends of the damper, one of which bases abuts against the top surface of the article and the other of which abuts against the ceiling, the grip member comprising:
a locking part locked to the base at the ceiling side; and
a grip part connected to the locking part and drooping below the ceiling side base in a mounted state in which the ceiling side base is in abutment against the ceiling.

2. The grip member according to claim 1, wherein:
the ceiling side base includes a body and a rotating shaft member which is assembled to the body and rotatably holds one of the ends of the damper;
the rotating shaft member has two ends respectively protruding at both sides of a central axis of the damper along a direction intersecting with the central axis; and
a pair of the locking parts is locked to the ends of the rotating shaft member respectively.

3. The grip member according to claim 2, further comprising connecting parts connected to the respective locking parts, wherein:
the connecting parts are caused to come close to each other so that a distance therebetween is shorter than a distance between the locking parts, thereby forming a narrowed part; and
the grip part is formed into an annular shape while located below the narrowed part, in the mounted state in which the ceiling side base is in abutment, against the ceiling.

4. The grip member according to claim 3, which is made of an elastically deformable material and is formed into an elongated shape in an extended state;
which is formed with one of the locking parts at a location near one of two longitudinal ends thereof and formed with the other locking part at a location near the longitudinal other end thereof;
which is formed with a through hole part located between the locking parts; and
which is attached to the ceiling side base in an intersecting state such that either connecting part is inserted through the through hole part.

5. The grip member according to claim 1, further comprising:
a first attachment member including the locking part and the grip part, the first attachment member being attached to the ceiling side base;
a second attachment member including a second locking part locked to the article side base and a second grip part connected to the second locking part, the second attachment member being attached to the article side base; and
a coupling member coupling the first and second attachment members,
wherein the first and second attachment members and the coupling member are connected to one another between the ceiling side base and the article side base, thereby holding the damper in a contracted state in which the damper has a desired length.

6. An overturn preventing device comprising the damper, the paired bases and the grip member all as defined in claim 1.

7. The grip member according to claim 4, further comprising:
a first attachment member including the locking part and the grip part, the first attachment member being attached to the ceiling side base;
a second attachment member including a second locking part locked to the article side base and a second grip part connected to the second locking part, the second attachment member being attached to the article side base; and
a coupling member coupling the first and second attachment members,
wherein the first and second attachment members and the coupling member are connected to one another between the ceiling side base and the article side base, thereby holding the damper in a contracted state in which the damper has a desired length.

8. An overturn preventing device comprising the damper, the paired bases and the grip member all as defined in claim 4.
